(19) United States
(12) Patent Application Publication
(10) Pub. No.: US 2015/0062056 A1
(43) Pub. Date: Mar. 5, 2015

(54) 3D GESTURE RECOGNITION FOR OPERATING AN ELECTRONIC PERSONAL DISPLAY

(71) Applicant: Kobo Incorporated, Toronto (CA)

(72) Inventors: Ryan SOOD, Toronto (CA); Damian LEWIS, Toronto (CA)

(73) Assignee: Kobo Incorporated, Toronto (CA)

(21) Appl. No.: 14/015,809

(22) Filed: Aug. 30, 2013

(51) Int. Cl. G06F 3/044; G06F 3/01

(52) U.S. Cl. CPC G06F 3/044; G06F 3/017
USPC 345/174

(57) ABSTRACT

A method and system for utilizing 3D gesture recognition for operating an electronic personal display is disclosed. One example receives a contact from a capacitive touch sensing surface on at least a portion of the electronic personal display. In addition, airspace in range of the 3D motion sensor coupled with the electronic personal display is monitored for a motion associated with the contact. The contact and motion are correlated with a predefined gesture denoting a digital reading operation to be performed on a digital content item rendered on the electronic personal display and the digital reading operation is performed on the electronic personal display.

### BACKGROUND

An electronic reader, also known as an eReader, is a mobile electronic device that is used for reading electronic books (eBooks), electronic magazines, and other digital content. For example, the content of an eBook is displayed as words and/or images on the display of an eReader such that a user may read the content much in the same way as reading the content of a page in a paper-based book. An eReader provides a convenient format to store, transport, and view a large collection of digital content that would otherwise potentially take up a large volume of space in traditional paper format.

In some instances, eReaders are purpose built devices designed especially to perform especially well at displaying readable content. For example, a purpose built eReader may include a display that reduces glare, performs well in high light conditions, and/or mimics the look of text on actual paper. While such purpose built eReaders may excel at displaying content for a user to read, they may also perform other functions, such as displaying images, emitting audio, recording audio, and web surfing, among others.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1A shows a front perspective view of an electronic reader (eReader), in accordance with various embodiments.

FIG. 1B shows a rear perspective view of the eReader of FIG. 1A, in accordance with various embodiments.

FIG. 2A shows a cross-section of the eReader of FIG. 1A along with a detail view of a portion of the display of the eReader, in accordance with various embodiments.

FIG. 2B shows a side perspective view of a 3D motion sensor, in accordance with various embodiments.

FIG. 3 shows a cutaway view of an eReader illustrating one example of a touch sensor, in accordance with an embodiment.

FIG. 4 shows an example computing system which may be included as a component of an eReader, according to various embodiments.

FIG. 5 shows a block diagram of a 3D gesture recognition system for an electronic personal display, according to various embodiments.

FIG. 6 illustrates a flow diagram of a method for utilizing 3D gesture recognition for operating an electronic personal display, according to various embodiments.

FIGS. 7A-D show top perspective views of a plurality of single-hand gestures for operating an electronic personal display, according to various embodiments.

FIGS. 8A-D show top perspective views of a plurality of single-hand gestures about a point for operating an electronic personal display, according to various embodiments.

FIGS. 9A-D show top perspective views of a plurality of paired-hand gestures for operating an electronic personal display, according to various embodiments.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “coupling”, “monitoring”, “detecting”, “generating”, “outputting”, “receiving”, “monitoring”, powering-up”, “powering down” or the like, often refer to the actions and processes of an electronic computing device/system, such as an electronic reader (“eReader”), electronic personal display, and/or a mobile (i.e., handheld) multimedia device, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview of Discussion

In the following discussion an electronic personal display gesture operating technology is disclosed. In one embodiment, the electronic personal display includes a capacitive touch sensor. One embodiment describes gestures that are performed to cause an electronic personal device to perform an action. For example, a gesture such as touching a capacitive touch sensor with an edge of a palm and then turning the hand to the right will cause the electronic personal device to open an e-book to start digital reading. Similarly, if the hand was turned to the left the electronic personal device may close an open e-book being read. In addition to a touch-sensitive display screen, a 3D motion sensor may be integrated into the electronic personal device, tablet or eReader. In general, the 3D gesture recognition technology will allow a user to make some type of finger, hand or body gesture to cause the reader/notebook to perform some type of operation. For example, the 3D motion sensor may indicate page turning to the left operation when a hand is moved to the left or a page turning to the right operation when a hand is moved to the right.

For purposes of the following discussion, the 3D motion sensor refers to a device that monitors a portion of airspace. When motion is detected within the portion of monitored airspace, the motion is mapped and compared with a number of predefined gestures. Each of the predefined gestures is also associated with an operation. In general, when the recognized motion correlates with a pre-defined gesture, the 3D motion sensor provides a signal to the eReader that the associated operation should be performed.

Discussion will begin with description of an example eReader and various components that may be included in some embodiments of an eReader. Various display and touch sensing technologies that may be utilized with some embodiments of an eReader will then be described. An example computing system, which may be included as a component of an eReader, will then be described. Operation of an example eReader and several of its components will then be described in more detail in conjunction with a description of an example method of utilizing a non-screen capacitive touch surface for operating an electronic personal display.

### Example Electronic Reader (eReader)

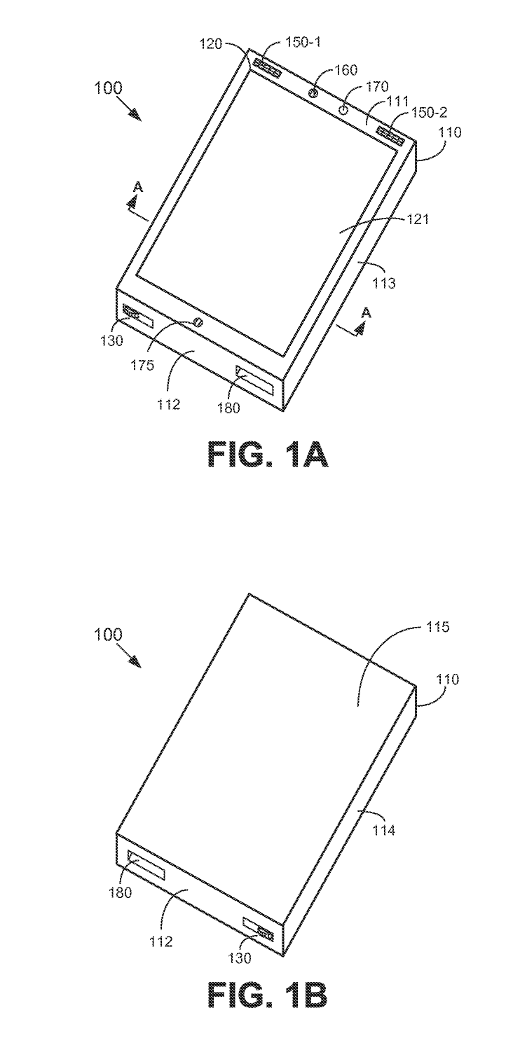

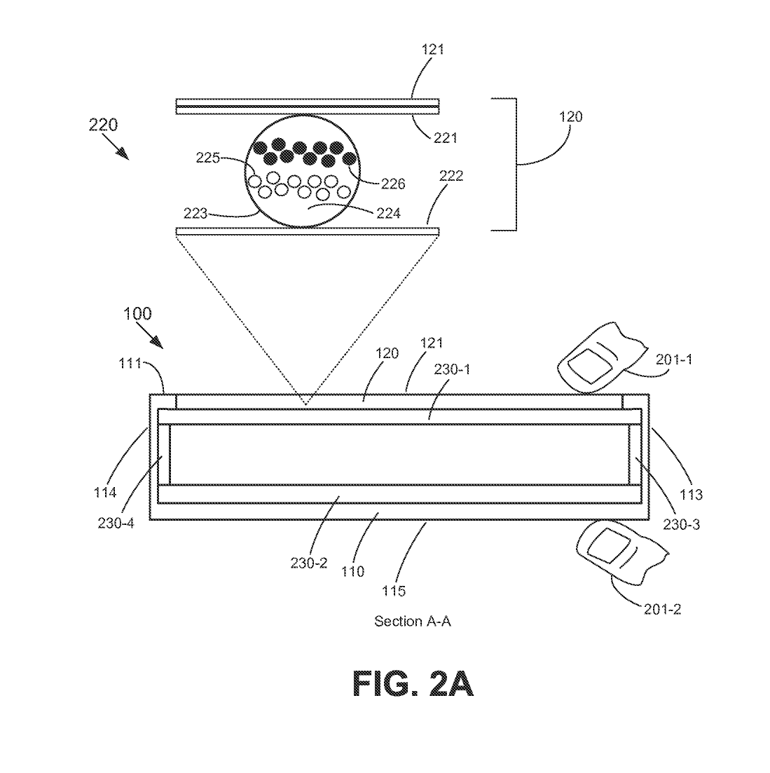

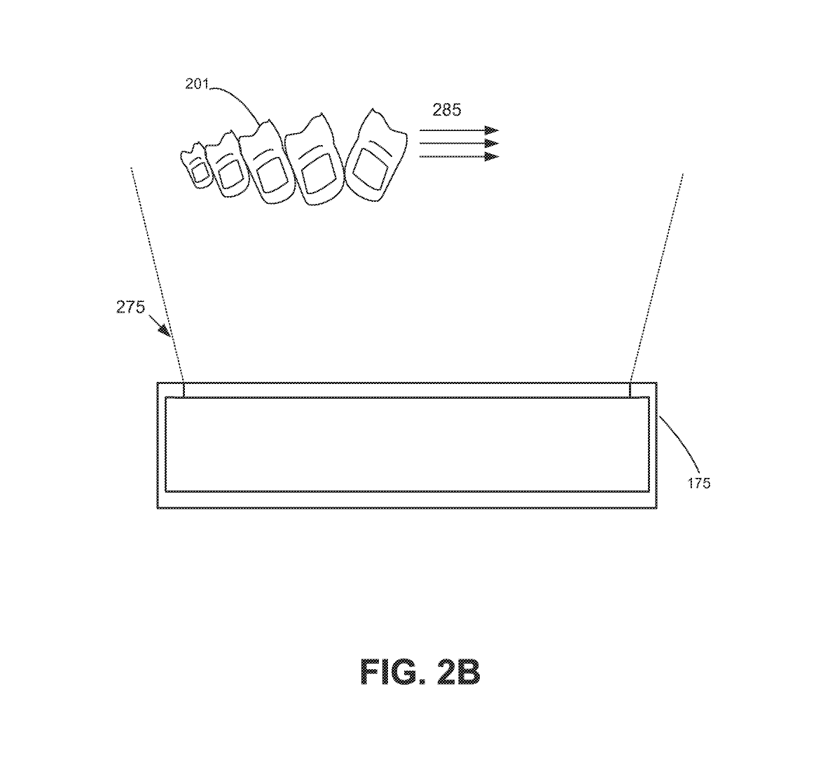

FIG. 1A shows a front perspective view of an eReader 100, in accordance with various embodiments. In general, eReader 100 is one example of an electronic personal display. Although an eReader is discussed specifically herein for purposes of example, concepts discussed are equally applicable to other types of electronic personal displays such as, but not limited to, mobile digital devices/tablet computers and/or multimedia smart phones. As depicted, eReader 100 includes a display 120, a housing 110, and some form of on/off switch 130. In some embodiments, eReader 100 may further include one or more of: speakers 150 (150-1 and 150-2 depicted), microphone 160, digital camera 170, 3D motion sensor 175 and removable storage media slot 180. Section lines depict a region and direction of a section A-A which is shown in greater detail in FIG. 2A.

Housing 110 forms an external shell in which display 120 is situated and which houses electronics and other components that are included in an embodiment of eReader 100. In FIG. 1A, a front surface 111, a bottom surface 112, and a right side surface 113 are visible. Although depicted as a single piece, housing 110 may be formed of a plurality of joined or inter-coupled portions. Housing 110 may be formed of a variety materials such as plastics, metals, or combinations of different materials.

Display 120 has an outer surface 121 (sometimes referred to as a bezel) through which a user may view digital contents such as alphanumeric characters and/or graphic images that are displayed on display 120. Display 120 may be any one of a number of types of displays including, but not limited to: a liquid crystal display, a light emitting diode display, a plasma display, a bistable display or other display suitable for creating graphic images and alphanumeric characters recognizable to a user.

On/off switch 130 is utilized to power on/power off eReader 100. On/off switch 130 may be a slide switch (as depicted), button switch, toggle switch, touch sensitive switch, or other switch suitable for receiving user input to power on/power off eReader 100.

Speaker(s) 150, when included, operates to emit audible sounds from eReader 100. A speaker 150 may reproduce sounds from a digital file stored on or being processed by eReader 100 and/or may emit other sounds as directed by a processor of eReader 100.

Microphone 160, when included, operates to receive audible sounds from the environment proximate eReader 100. Some examples of sounds that may be received by microphone 160 include voice, music, and/or ambient noise in the area proximate eReader 100. Sounds received by microphone 160 may be recorded to a digital memory of eReader 100 and/or processed by a processor of eReader 100.

Digital camera 170, when included, operates to receive images from the environment proximate eReader 100. Some examples of images that may be received by digital camera 170 include an image of the face of a user operating eReader 100 and/or an image of the environment in the field of view of digital camera 170. Images received by digital camera 170 may be still or moving and may be recorded to a digital memory of eReader 100 and/or processed by a processor of eReader 100.

3D motion sensor 175, when included, monitors for motion within a portion of airspace in the environment proximate eReader 100. Some examples of motion that may be detected include sideways motions, up and down motions, depth motions and a combination of the afore mentioned motions. Granularity with respect to the level of motion detected by 3D motion sensor 175 may be preset or user adjustable. Motions detected by 3D motion sensor 175 may be recorded to a digital memory of eReader 100 and/or processed by a processor of eReader 100. In one embodiment, 3D motion sensor 175 is fixedly coupled with housing 110 of eReader 100. However, in another embodiment, 3D motion sensor 175 may be removably coupled with eReader 100 such as a wired or wireless connection.

Removable storage media slot 180, when included, operates to removably couple with and interface to an inserted item of removable storage media, such as a non-volatile memory card (e.g., MultiMediaCard (“MMC”), a secure digital (“SD”) card, or the like). Digital content for play by eReader 100 and/or instructions for eReader 100 may be stored on removable storage media inserted into removable storage media slot 180. Additionally or alternatively, eReader 100 may record or store information on removable storage media inserted into removable storage media slot 180.

FIG. 1B shows a rear perspective view of eReader 100 of FIG. 1A, in accordance with various embodiments. In FIG. 1B, a rear surface 115 of the non-display side of the housing 110 of eReader 100 is visible. Also visible in FIG. 1B is a left side surface 114 of housing 110. It is appreciated that housing 110 also includes a top surface which is not visible in either FIG. 1A or FIG. 1B.

FIG. 2A shows a cross-section A-A of eReader 100 along with a detail view 220 of a portion of display 120, in accordance with various embodiments. In addition to display 120 and housing 110, a plurality of touch sensors 230 are visible and illustrated in block diagram form. It should be appreciated that a variety of well-known touch sensing technologies may be utilized to form touch sensors 230 that are included in embodiments of eReader 100; these include, but are not limited to: resistive touch sensors; capacitive touch sensors (using self and/or mutual capacitance); inductive touch sensors; and infrared touch sensors. In general, resistive touch sensing responds to pressure applied to a touched surface and is implemented using a patterned sensor design on, within, or beneath display 120, rear surface 115, and/or other surface of housing 110. In general, inductive touch sensing requires the use of a stylus and are implemented with a patterned electrode array disposed on, within, or beneath display 120, rear surface 115, and/or other surface of housing 110 In general, capacitive touch sensing utilizes a patterned electrode array disposed on, within, or beneath display 120, rear surface 115, and/or other surface of housing 110; and the patterned electrodes sense changes in capacitance caused by the proximity or contact by an input object. In general, infrared touch sensing operates to sense an input object breaking one or more infrared beams that are projected over a surface such as outer surface 121, rear surface 115, and/or other surface of housing 110.

Once an input object interaction is detected by a touch sensor 230, it is interpreted either by a special purpose processor (e.g., an application specific integrated circuit (ASIC)) that is coupled with the touch sensor 230 and the interpretation is passed to a processor of eReader 100, or a processor of eReader is used to directly operate and/or interpret input object interactions received from a touch sensor 230. It should be appreciated that in some embodiments, patterned sensors and/or electrodes may be formed of optically transparent material such as very thin wires or a material such as indium tin oxide (ITO).

In various embodiments one or more touch sensors 230 (230-1 front; 230-2 rear; 230-3 right side; and/or 230-4 left side) may be included in eReader 100 in order to receive user input from input object 201 such as styli or human digits. For example, in response to proximity or touch contact with outer surface 121 or coversheet (not illustrated) disposed above outer surface 121, user input from one or more fingers such as finger 201-1 may be detected by touch sensor 230-1 and interpreted. Such user input may be used to interact with graphical content displayed on display 120 and/or to provide other input through various gestures (e.g., tapping, swiping, pinching digits together on outer surface 121, spreading digits apart on outer surface 121, or other gestures).

In a similar manner, in some embodiments, a touch sensor 230-2 may be disposed proximate rear surface 115 of housing 110 in order to receive user input from one or more input objects 201, such as human digit 201-2. In this manner, user input may be received across all or a portion of the rear surface 115 in response to proximity or touch contact with rear surface 115 by one or more user input objects 201. In some embodiments, where both front (230-1) and rear (230-2) touch sensors are included, a user input may be received and interpreted from a combination of input object interactions with both the front and rear touch sensors.

In a similar manner, in some embodiments, a left side touch sensor 230-3 and/or a right side touch sensor 230-4, when included, may be disposed proximate the respective left and/or right side surfaces (113, 114) of housing 110 in order to receive user input from one or more input objects 201. In this manner, user input may be received across all or a portion of the left side surface 113 and/or all or a portion of the right side surface 114 of housing 110 in response to proximity or touch contact with the respective surfaces by or more user input objects 201. In some embodiments, instead of utilizing a separate touch sensor, a left side touch sensor 230-3 and/or a right side touch sensor 230-4 may be a continuation of a front touch sensor 230-1 or a rear touch sensor 230-2 which is extended so as to facilitate receipt proximity/touch user input from one or more sides of housing 110.

Although not depicted, in some embodiments, one or more touch sensors 230 may be similarly included and situated in order to facilitate receipt of user input from proximity or touch contact by one or more user input objects 201 with one or more portions of the bottom 112 and/or top surfaces of housing 110.

Referring still to FIG. 2A, a detail view 220 is show of display 120, according to some embodiments. Detail 220 depicts a portion of a bistable electronic ink that is used, in some embodiments, when display 120 is a bistable display. In some embodiments, a bistable display is utilized in eReader 100 as it presents a paper and ink like image and/or because it is a reflective display rather than an emissive display and thus can present a persistent image on display 120 even when power is not supplied to display 120. In one embodiment, a bistable display comprises electronic ink the form of millions of tiny optically clear capsules 223 that are filled with an optically clear fluid 224 in which positively charged white pigment particles 225 and negatively charged black pigment particles 226 are suspended. The capsules 223 are disposed between bottom electrode 222 and a transparent top electrode 221. A transparent/optically clear protective surface is often disposed over the top of top electrode 221 and, when included, this additional transparent surface forms outer surface 121 of display 120 and forms a touch surface for receiving touch inputs. It should be appreciated that one or more intervening transparent/optically clear layers may be disposed between top electrode 221 and top electrode 221. In some embodiments, one or more of these intervening layers may include a patterned sensor and/or electrodes for touch sensor 230-1. When a positive or negative electric field is applied proximate to each of bottom electrode 222 and top electrode 221 in regions proximate capsule 223, pigment particles of opposite polarity to a field are attracted to the field, while pigment particles of similar polarity to the applied field are repelled from the field. Thus, when a positive charge is applied to top electrode 221 and a negative charge is applied to bottom electrode 221, black pigment particles 226 rise to the top of capsule 223 and white pigment particles 225 go to the bottom of capsule 223. This makes outer surface 121 appear black at the point above capsule 223 on outer surface 121. Conversely, when a negative charge is applied to top electrode 221 and a positive charge is applied to bottom electrode 221, white pigment particles 225 rise to the top of capsule 223 and black pigment particles 226 go to the bottom of capsule 223. This makes outer surface 121 appear white at the point above capsule 223 on outer surface 121. It should be appreciated that variations of this technique can be employed with more than two colors of pigment particles.

FIG. 2B shows a 3D motion sensor 175 with a range 275 within which motion may be sensed to receive user input. In various embodiments one or more 3D motion sensor 175 may be included in eReader 100 in order to receive user input from input object 201 such as styli or human digits. For example, in response to a motion 285 within the airspace 275, user input from one or more fingers such as fingers 201 may be detected by 3D motion sensor 175 and interpreted. Such user input may be used to interact with graphical content displayed on display 120 and/or to provide other input through various gestures. In general, 3D motion sensor 175 may recognize motions performed in one or more of the x-, y- and z-axis. For example, a side-to-side motion would be differentiated from an up and down motion. Moreover, depending on the desired granularity of the 3D motion sensor 175 additional differentiations may be made between a horizontal side-to-side motion and a sloping side-to-side motion. In one embodiment, the 3D motion sensor 175 may be incorporated with digital camera 170 into a single device.

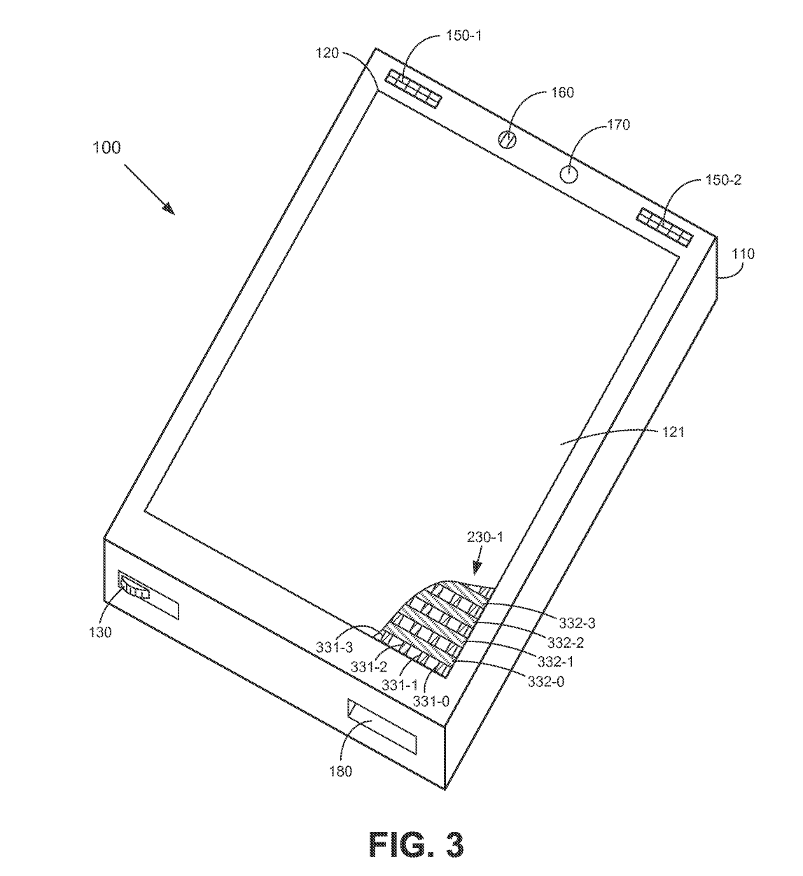

FIG. 3 shows a cutaway view of an eReader illustrating one example of a touch sensor 230, in accordance with an embodiment. In FIG. 3, a portion of display 120 has been removed such that a portion of underlying top sensor 230-1 is visible. As depicted, in one embodiment, top touch sensor 230-1 is illustrated as an x-y grid of sensor electrodes which may be used to perform various techniques of capacitive sensing. For example, sensor electrodes 331 (331-0, 331-1, 331-2, and 331-3 visible) are arrayed along a first axis, while sensor electrodes 332 (332-0, 332-1, 332-2, and 332-3 visible) are arrayed along a second axis that is approximately perpendicular to the first axis. It should be appreciated that a dielectric layer (not illustrated) is disposed between all or portions of sensor electrodes 331 and 332 to prevent shorting. It should also be appreciated that the pattern of sensor electrodes (331, 332) illustrated in FIG. 3 has been provided an example only, that a variety of other patterns may be similarly utilized, and some of these patterns may only utilize sensor electrodes disposed in a single layer. Additionally, while the example of FIG. 3 illustrates top sensor 230-1 as being disposed beneath display 120, in other embodiments, portions of touch sensor 230-1 may be transparent and disposed either above display 120 or integrated with display 120.

In one embodiment, by performing absolute/self-capacitive sensing with sensor electrodes 331 on the first axis a first profile of any input object contacting outer surface 121 can be formed, and then a second profile of any input object contacting outer surface 121 can be formed on an orthogonal axis by performing absolute/self-capacitive sensing on sensor electrodes 332. These capacitive profiles can be processed to determine an occurrence and/or location of a user input with made by means of an input object 201 contacting or proximate outer surface 121.

In another embodiment, by performing transcapacitive/mutual capacitive sensing between sensor electrodes 331 on the first axis and sensor electrodes 332 on the second axis a capacitive image can be formed of any input object contacting outer surface 121. This capacitive image can be processed to determine occurrence and/or location of user input made by means of an input object contacting or proximate outer surface 121.

It should be appreciated that mutual capacitive sensing is regarded as a better technique for detecting multiple simultaneous input objects in contact with a surface such as outer surface 121, while absolute capacitive sensing is regarded as a better technique for proximity sensing of objects which are near but not necessarily in contact with a surface such as outer surface 121.

In some embodiments, capacitive sensing and/or another touch sensing technique may be used to sense touch input across all or a portion of the rear surface 115 of eReader 100, and/or any other surface(s) of housing 110.

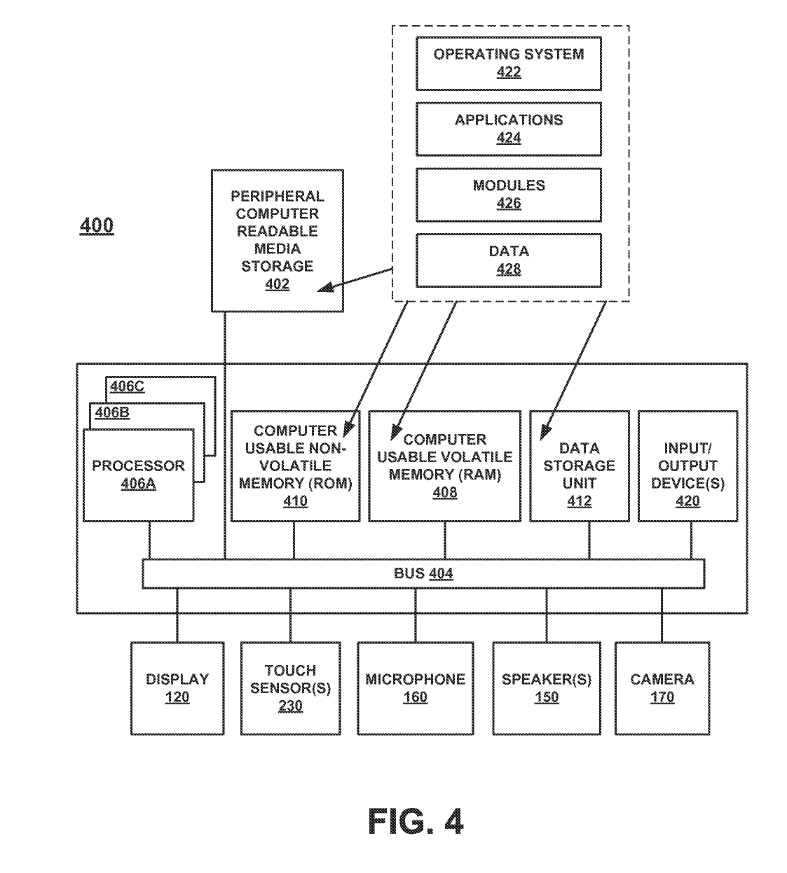

FIG. 4 shows an example computing system 400 which may be included as a component of an eReader, according to various embodiments and with which or upon which various embodiments described herein may operate.

### Example Computer System Environment

With reference now to FIG. 4, all or portions of some embodiments described herein are composed of computer-readable and computer-executable instructions that reside, for example, in computer-usable/computer-readable storage media of a computer system. That is, FIG. 4 illustrates one example of a type of computer (computer system 400) that can be used in accordance with or to implement various embodiments of an eReader, such as eReader 100, which are discussed herein. It is appreciated that computer system 400 of FIG. 4 is only an example and that embodiments as described herein can operate on or within a number of different computer systems.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Processors 406A. 406B, and 406C may be any of various types of microprocessors. For example, in some multi-processor embodiments, one of the multiple processors may be a touch sensing processor and/or one of the processors may be a display processor. Conversely, system 400 is also well suited to having a single processor such as, for example, processor 406A. System 400 also includes data storage features such as a computer usable volatile memory 408, e.g., random access memory (RAM), coupled to bus 404 for storing information and instructions for processors 406A, 406B, and 406C. System 400 also includes computer usable non-volatile memory 410, e.g., read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions.

Computer system 400 of FIG. 4 is well adapted to having peripheral computer-readable storage media 402 such as, for example, a floppy disk, a compact disc, digital versatile disc, universal serial bus “flash” drive, removable memory card, and the like coupled thereto. In some embodiments, computer-readable storage media 402 may be coupled with computer system 400 (e.g., to bus 404) by insertion into removable a storage media slot, such as removable storage media slot 180 depicted in FIGS. 1A and 1B.

System 400 also includes or couples with display 120 for visibly displaying information such as alphanumeric text and graphic images. In some embodiments, system 400 also includes or couples with one or more optional touch sensors 230 for communicating information, cursor control, gesture input, command selection, and/or other user input to processor 406A or one or more of the processors in a multi-processor embodiment. In some embodiments, system 400 also includes or couples with one or more optional speakers 150 for emitting audio output. In some embodiments, system 400 also includes or couples with an optional microphone 160 for receiving/capturing audio inputs. In some embodiments, system 400 also includes or couples with an optional digital camera 170 for receiving/capturing digital images as an input.

Optional touch sensor(s) 230 allows a user of computer system 400 (e.g., a user of an eReader of which computer system 400 is a part) to dynamically signal the movement of a visible symbol (cursor) on display 120 and indicate user selections of selectable items displayed on display 120. In some embodiment other implementations of a cursor control device and/or user input device may also be included to provide input to computer system 400, a variety of these are well known and include: trackballs, keypads, directional keys, and the like. System 400 is also well suited to having a cursor directed or user input received by other means such as, for example, voice commands received via microphone 160. System 400 also includes an input/output (I/O) device 420 for coupling system 400 with external entities. For example, in one embodiment, I/O device 420 is a modem for enabling wired communications or modem and radio for enabling wireless communications between system 400 and an external device and/or external network such as, but not limited to, the Internet. I/O device 120 may include a short-range wireless radio such as a Bluetooth® radio, Wi-Fi radio (e.g., a radio compliant with Institute of Electrical and Electronics Engineers' (IEEE) 802.11 standards), or the like.

Referring still to FIG. 4, various other components are depicted for system 400. Specifically, when present, an operating system 422, applications 424, modules 426, and/or data 428 are shown as typically residing in one or some combination of computer usable volatile memory 408 (e.g., RAM), computer usable non-volatile memory 410 (e.g., ROM), and data storage unit 412. In some embodiments, all or portions of various embodiments described herein are stored, for example, as an application 424 and/or module 426 in memory locations within RAM 408, ROM 410, computer-readable storage media within data storage unit 412, peripheral computer-readable storage media 402, and/or other tangible computer readable storage media.

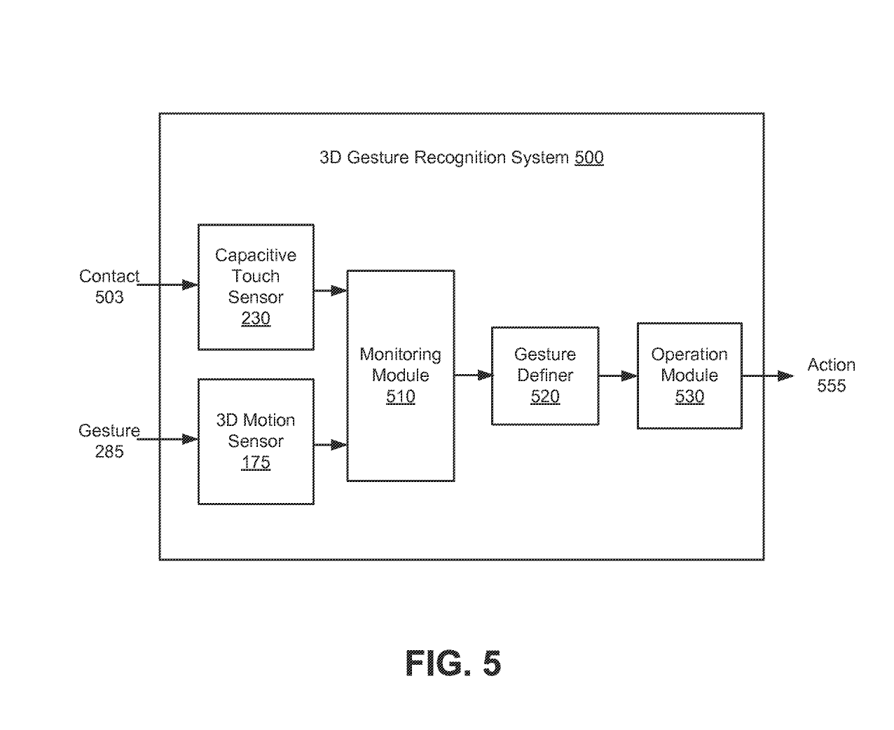

With reference now to FIG. 5, a block diagram of 3D gesture recognition system 500 for an electronic personal display is shown in accordance with an embodiment. One example of an electronic personal display is an electronic reader (eReader).

In one embodiment, 3D gesture recognition system 500 includes a capacitive touch sensor 230 on at least a portion of a housing 110 of the electronic personal display, a 3D motion sensor 175 coupled with the electronic personal display, a monitoring module 510, a gesture definer 520 and an operation module 530 that provides an action 555. Although the components are shown as distinct objects in the present discussion, it is appreciated that the operations of one or more of the components may be combined into a single module. Moreover, it is also appreciated that the actions performed by a single module described herein could also be broken up into actions performed by a number of different modules or performed by a different module altogether. The present breakdown of assigned actions and distinct modules are merely provided herein for purposes of clarity.

In one embodiment, capacitive touch sensor 230 is located on an edge of the housing. In another embodiment, capacitive touch sensor 230 is located on a rear surface 115 of housing 110. In yet another embodiment, capacitive touch sensor 230 covers the entire housing 110. In general, the capabilities and characteristics of capacitive touch sensor 230 on at least a portion of a housing 110 of the electronic personal display are described in detail herein in the discussion of FIGS. 1-3. As such, for purposes of clarity, instead of repeating the discussion provided in respect to FIGS. 1-3, the discussion of FIGS. 1-3 is incorporated by reference in its entirety herein.

In one embodiment, monitoring module 510 monitors output from capacitive touch sensor 230. For example, when a contact 503, such as by finger 201-1 occurs, a signal is output from the capacitive touch sensor 230 in the area that was touched. In addition to receiving information from capacitive touch sensor 230, monitoring module 510 also receives motion information from 3D motion sensor 175. For example, when a motion 285, such as by fingers 201 occurs, a signal is output from 3D motion sensor 175 regarding the motion that was performed. In one embodiment, monitoring module 510 combines the contact 503 and the motion 285 into a single gesture based output.

Gesture definer 520 receives the gesture based output from monitoring module 510 and correlates the gesture with an action to be performed by the electronic personal display. In general, the gesture-action correlation may be factory set, user adjustable, user selectable, or the like. Additionally, the gesture-action performed correlation with the gesture-action for an operation correlation may be adjustable. In one embodiment, if the user's gesture-action is not an exact match to a pre-defined gesture, but is a proximate match for the operation, the correlation settings could be widened such that a gesture with a medium correlation is recognized, or the settings could be narrowed such that only a gesture with a high correlation to the pre-defined gesture will be recognized. For example, in reader mode the correlation settings may be widened such that an open handed gesture from right to left may be indicative of the page turning operation. However, during other operations with higher correlation requirements, the same gesture may be too broad and not be recognized as correlating with any pre-defined gesture-action operations.

Once a gesture-action correlation is determined, gesture definer 520 provides an input to operation module 530 to initiate the requested action. Operation module 530 then initiates the action 555. In one embodiment, the contact may be a factory defined gesture, a user adjustable gesture, a combination of touches, or may be defined by a user definable metric. In other words, the user may correlate a defined contact type with a defined operation to be performed by the electronic personal display. In one embodiment, the operation to be performed may include, but is not limited to, opening a book, closing an eBook, turning a page, adding a bookmark, removing a bookmark, opening a menu, a change in brightness, a reading mode change and the like.

### Example Method of Utilizing Gesture Recognition for Operating an Electronic Personal Display

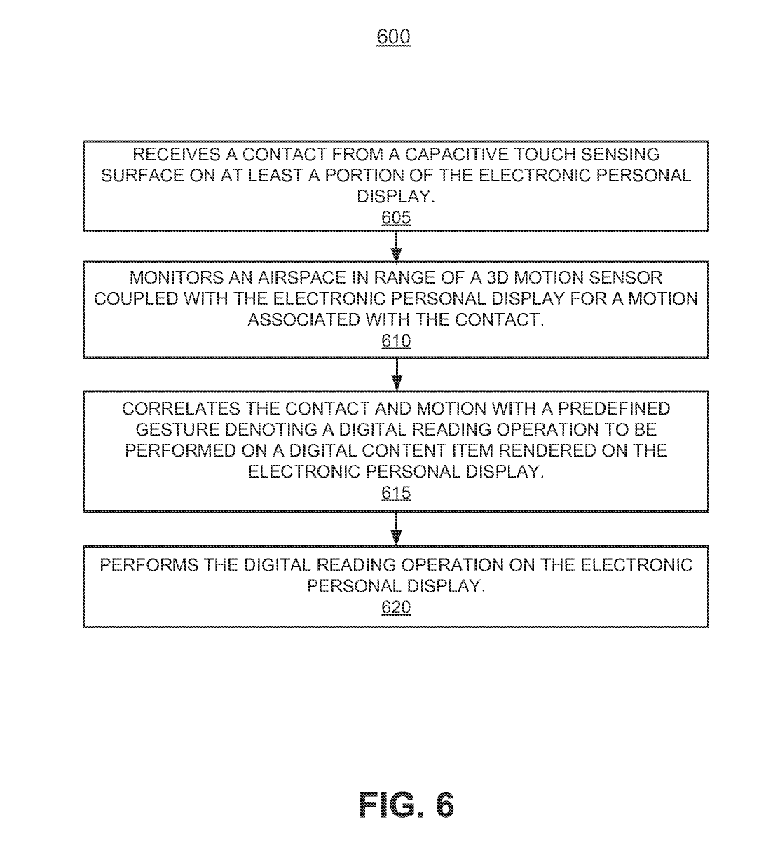

FIG. 6 illustrates a flow diagram 600 of a method of utilizing 3D gesture recognition for operating an electronic personal display according to various embodiments. In one embodiment, the electronic personal display is an electronic reader (eReader). Elements of flow diagram 600 are described below, with reference to elements of one or more of FIGS. 1-5.

With reference now to 605 of FIG. 6 and to FIGS. 2A-2B and 5, one embodiment receives a contact at a capacitive touch sensing surface on at least a portion of the electronic personal display 100. In general, the capacitive touch surface may be, but is not limited to, a grid of conductive lines, a coat of metal, a flexible printed circuit grid and the like. In addition, the capacitive touch sensing surface may utilize directional sensitivity to provide touch-based gesture capabilities.

In one embodiment, the capacitive touch sensing surface may be on only portions of the screen 120, housing 110, sides of housing 110, edges of housing 110, corners of housing 110, rear surface 115 of housing 110, on the entire housing 110, or a combination thereof. For example, the capacitive touch sensing surface may be on one or more of the front surface 111, bottom surface 112, right side surface 113, left side surface 114, rear surface 115, and the top surface (not shown) of housing 110 of eReader 100.

In another embodiment, since housing 110 of the electronic personal display includes one or more capacitive touch sensing surface(s), screen 120 may not necessarily be a capacitive touch sensing surface. Instead, each touch or gesture that would normally be performed on the screen would instead be performed on the housing. In so doing, screen manufacturing costs may be reduced. Additionally, by moving the capacitive touch sensing surface away from the screen, the screen would not be subject to as much touching, swiping, tapping and the like and would provide a cleaner reading surface. However, in another embodiment, the screen of the electronic personal display may have a capacitive touch sensing surface.

In one embodiment, no hard buttons are required for the electronic personal display. That is, there is no need for a hard button on eReader 100 since the capacitive touch sensing surface of the housing 110 is monitored for gestures. In so doing, a greater robustness with regard to dust, fluid contaminants, sand and the like can be achieved. In other words, by removing the hard buttons there are fewer openings through which sand, debris or water can enter the device. Moreover, robustness of the electronic personal display is enhanced since there is no hard button to get gummed up, stuck, spilled on, broken, dropped, dirty, dusty and the like. In an embodiment where no power-up hard button is included, on off switch 130 of FIGS. 1A, 1B, and 3 is replaced by a smooth surface of housing 110 and a touch sensing surface is used to perform the functions of on/off switch 130.

Referring now to 610 of FIG. 6 and to FIGS. 2A-2B and 5, one embodiment monitors airspace in range of a 3D motion sensor 175 coupled with the electronic personal display 100 for a motion associated with the contact. For example, when a contact 503 occurs, a signal is output from the capacitive touch sensor 230 in the area that was touched. In addition 3D motion sensor 175 will provide a signal describing motion information that was performed in the monitored airspace 275 within a predefined time period of the contact 503. The contact 503 and the motion 285 that occurred around the time of contact 503 will then be combined into a single gesture based output.

In one embodiment the predefined time period may be a time window around the time of contact 503. For example, 3D motion sensor 175 may be continuously monitoring airspace 275 for user motions and storing any motions in a looping storage database. When a contact 503 occurs, the monitoring module 510 may refer to the storage database for any motion information that occurred within a predefined time period prior to the contact. For example, monitoring module 510 may refer to a two second time period prior to the contact 503 for any motion information.

In another embodiment, the predefined time period may be a time window that occurs after the time of contact 503. For example, 3D motion sensor 175 may be in a low power state and not monitor airspace 275 for user motions until a contact 503 has occurred. When a contact 503 occurs, the signal would cause 3D motion sensor 175 to begin monitoring the airspace 275 for a certain period of time. For example, 3D motion sensor 175 may commence a two-to-five second time period after contact 503 for any motion information. Although a number of predefined time periods are discussed for purposes of clarification, the actual monitored time period may be greater or less than the stated times.

In one embodiment, 3D motion sensor 175 is fixedly coupled with housing 110 of eReader 100. However, in another embodiment, 3D motion sensor 175 may be removably coupled with eReader 100 such as a wired or wireless connection.

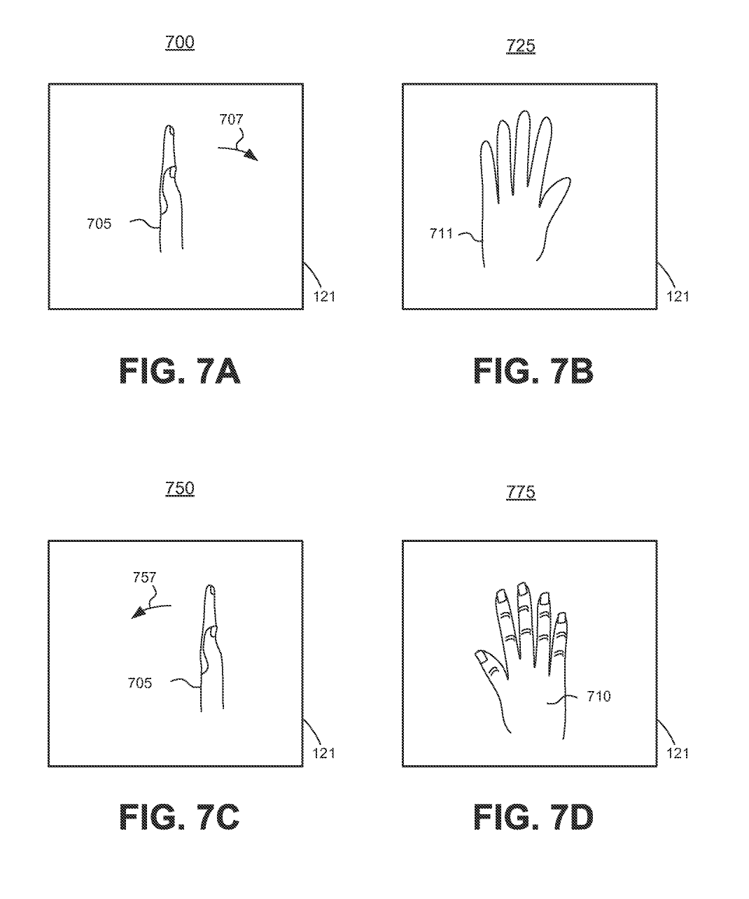

Referring now to 615 of FIG. 6 and to FIGS. 2A-2B and 5, one embodiment correlates the contact 503 and motion 285 with a predefined gesture denoting a digital reading operation to be performed on a digital content item rendered on the electronic personal display. In general, the types of contact 503 and motions 285 that may be correlated to become a predefined gesture may be wide ranging and could be additionally expanded by a user's individual preferences. For example, a factory pre-defined gesture may include a contact followed by a right-left motion related to a page turn operation, a contact followed by a hands closing motion related to a book closing operation, a contact followed by a hands opening motion related to a book opening operation and the like. A number of pre-defined gestures are shown in FIGS. 7A-9C and are discussed in further detail herein.

Moreover, the user may expand the predefined gestures by developing and storing individualized gestures. For example, one user may define a bookmarking operation as a contact followed by a checkmark type of motion while another user may define a bookmarking operation as a contact followed by an “ok” motion.

With reference now to 620 of FIG. 6 and to FIGS. 2A-2B and 5, one embodiment performs the digital reading operation on the electronic personal display, where the operation being performed is dependent upon the type of contact detected. For example, in the following discussion of FIGS. 7A-9C, a number of predefined gestures for performing operations such as, but not limited to, book opening, book closing, forward page turn, backward page turn and bookmarking are shown. In the following discussion a number of terms such as back of the hand, palm of the hand and knife edge of a hand are utilized. In general, back of the hand refers to the knuckled side of a hand while palm of the hand refers to the side of a hand that includes the fingerprints. A knife edge of a hand refers to a side portion of the hand that includes the pinkie finger and the side portion of the palm, similar to a karate chop type of hand orientation.

Referring now to FIGS. 7A-7D top perspective views of a plurality of single-hand motions for operating an electronic personal display are shown according to various embodiments. FIGS. 7A-7B illustrate one embodiment of a single-hand open book pre-defined motion while FIGS. 7C-7D illustrate one embodiment of a single-hand close book pre-defined motion.

In FIG. 7A, diagram 700 shows a surface 121 with a knife edge 705 contact thereon and a directional arrow 707 showing a clockwise direction of rotation for the hand. In diagram 725 of FIG. 7B the hand is now rotated to a palm up position 711. Thus, in one embodiment, the combined contact and motion for opening a book involves a user initially contacting the knife edge of a user's right hand with surface 121 and then rotating the hand clockwise from the knife edge 705 to a palm up position 711 in a clockwise rotating motion. Although a user's right hand is shown and described, the user's left hand may also be used.

In operation, when monitoring module 510 receives the corresponding signals from capacitive touch sensor 230 and 3D motion sensor 175, monitoring module 510 will determine that the display screen has been touched with a knife edge of a palm and then the hand was rotated clockwise to a palm up orientation. In one embodiment, monitoring module 510 will provide the unified gesture to gesture definer 520 which will correlate the contact and following motion with the action “open an e-book to start digital reading”. Gesture definer 520 will then signal operation module 530 to perform the above stated action 555.

Referring now to the close book pre-defined gestures of FIGS. 7C-7D, in FIG. 7C, diagram 750 shows a surface 121 with a knife edge 705 contact thereon and a directional arrow 757 showing a counter-clockwise direction of rotation for the hand. In diagram 775 of FIG. 7D the hand is now rotated to a palm down position 710. Thus, in one embodiment, the combined contact and motion for closing a book involves a user initially contacting the knife edge 705 of a user's right hand with surface 121 and then rotating the hand counter-clockwise from the knife edge 705 to a palm down position 710.

In operation, when monitoring module 510 receives the corresponding signals from capacitive touch sensor 230 and 3D motion sensor 175, monitoring module 510 will determine that the display screen has been touched with a knife edge of a palm and then the hand was rotated counter-clockwise to a palm down orientation. In one embodiment, monitoring module 510 will provide the unified gesture to gesture definer 520 which will correlate the contact and following motion with the action “close an e-book”. Gesture definer 520 will then signal operation module 530 to perform the above stated action 555.

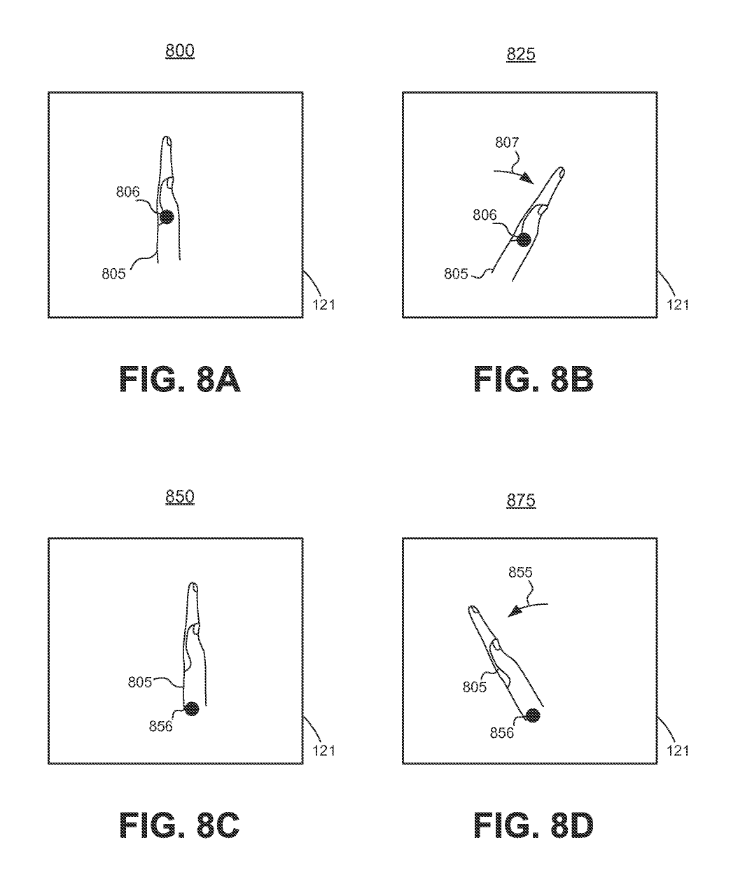

Referring now to FIGS. 8A-8D a top perspective views of a plurality of single-hand motions about a point for operating an electronic personal display are shown according to various embodiments. In general, the contacts and motions of FIGS. 8A-8D may be used to signal page turning operations, bookmarking operations and the like.

In FIG. 8A, diagram 800 shows a surface 121 with a knife edge 805 contact thereon and a rotational axis 806 through a thumb joint of a user's hand. In diagram 825 of FIG. 8B the hand 805 is now rotated in direction 807 again about a rotational axis 806. Although direction 807 is clockwise, it should be appreciated that the direction of rotation about axis 806 may be in either direction. Moreover, although a user's right hand is shown and described, the user's left hand may also be used. In one embodiment, the rotation is done, whether for opening or closing, while the little finger/edge-of-palm maintains contact with the device surface 121.

For example, in one embodiment, the combined contact and motion for paging backward involves a user initially contacting the knife edge 805 of a user's right hand and then rotating the knife edge 805 about rotational axis 806 in a clockwise rotating motion. In another embodiment, the combined contact and motion for paging forward involves a user initially contacting the knife edge 805 of a user's right hand and then rotating the knife edge 805 about rotational axis 806 in a counter-clockwise rotating motion. In yet another embodiment, the combined contact and motion described above may be used for bookmarking a page.

In operation, when monitoring module 510 receives the corresponding signals from capacitive touch sensor 230 and 3D motion sensor 175, monitoring module 510 will determine that the display screen has been contacted with the knife edge 805 of a user's right hand and then the knife edge 805 was rotated about rotational axis 806 in a clockwise rotating motion. In one embodiment, monitoring module 510 will provide the unified gesture to gesture definer 520 which will correlate the contact and following motion with the action “page backward”. Gesture definer 520 will then signal operation module 530 to perform the above stated action 555.

Referring now to the page forward pre-defined gestures of FIGS. 8C-8D, in FIG. 8C, diagram 850 shows a surface 121 with a knife edge 805 contact thereon and a rotational axis 856 through a user's wrist area. In diagram 875 of FIG. 8D, hand 805 is now rotated in direction 855 again about a rotational axis 856. Although direction 855 is counter-clockwise, it should be appreciated that the direction of rotation about axis 855 may be in either direction. Moreover, although a user's right hand is shown and described, the user's left hand may also be used.

For example, in one embodiment, the combined contact and motion for paging forward involves a user initially contacting the knife edge 805 of a user's right hand and then rotating the knife edge 805 about rotational axis 855 in a counter-clockwise rotating motion. In another embodiment, the combined contact and motion for paging backward involves a user initially contacting the knife edge 805 of a user's right hand and then rotating the knife edge 805 about rotational axis 856 in a clockwise rotating motion. In yet another embodiment, the combined contact and motion described above may be used for bookmarking a page.

In operation, when monitoring module 510 receives the corresponding signals from capacitive touch sensor 230 and 3D motion sensor 175, monitoring module 510 will determine that the display screen has been contacted with the knife edge 805 of a user's right hand and then the knife edge 805 was rotated about rotational axis 856 in a counter-clockwise rotating motion. In one embodiment, monitoring module 510 will provide the unified gesture to gesture definer 520 which will correlate the contact and following motion with the action “page forward”. Gesture definer 520 will then signal operation module 530 to perform the above stated action 555.

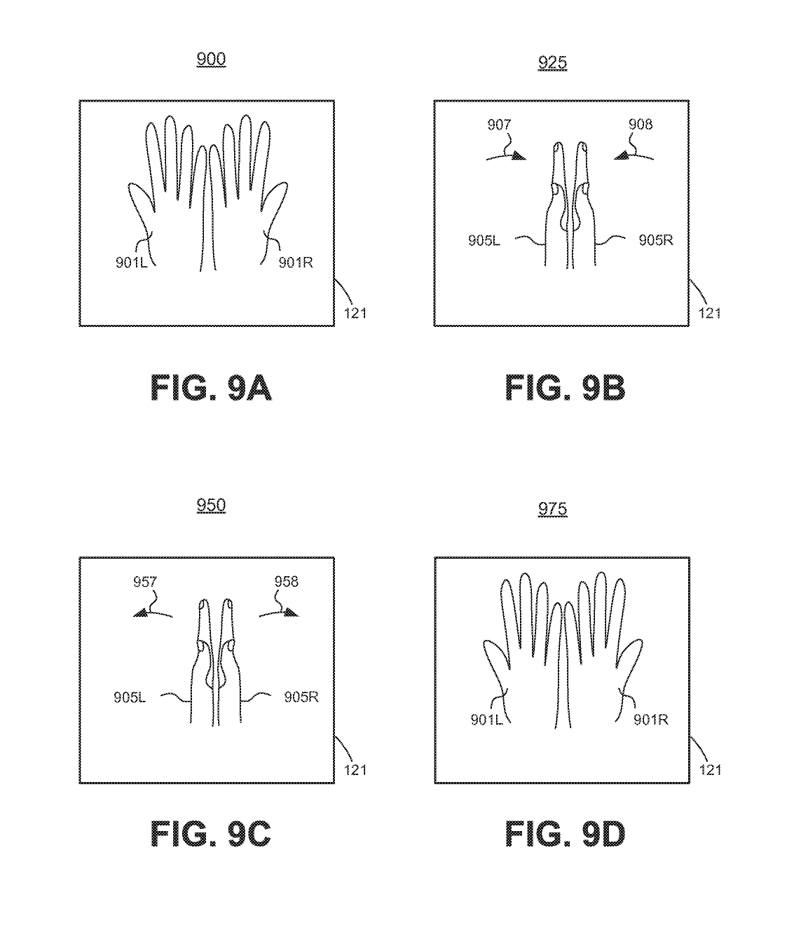

Referring now to FIGS. 9A-9D, top perspective views of a plurality of paired-hand motions for operating an electronic personal display are shown according to various embodiments. FIGS. 9A-9B illustrate one embodiment of a two handed close book pre-defined gesture while FIGS. 9C-9D illustrate one embodiment of a two handed open book pre-defined gesture.

In FIG. 9A, diagram 900 shows a surface 121 with a left hand palm up 901L contact and a right hand palm up 901R contact thereon. In diagram 925 of FIG. 9B the hands are now rotated into a closed position such that the contact with surface 121 consists of a left hand knife edge 905L contact and a right hand knife edge 905R contact. The direction of rotation for left hand 901L is shown by directional arrow 907 while the direction of rotation for right hand 901R is shown by directional arrow 908. In other words, the user initially places the backs of both hands on the surface 121 and then rotates each hand about its knife edge until the palms of each hand are touching one another. In one embodiment, the knife edge of each hand is in contact with surface 121 at the completion of the rotating motion.

In operation, when monitoring module 510 receives the corresponding signals from capacitive touch sensor 230 and 3D motion sensor 195, monitoring module 510 will determine that the display screen has been touched and then the user's hands performed a close together motion. In one embodiment, monitoring module 510 will provide the unified gesture to gesture definer 520 which will correlate the contact and following motion with the action “close an e-book”. Gesture definer 520 will then signal operation module 530 to perform the above stated action 555.

Referring now to the open book pre-defined gestures of FIGS. 9C-9D, in FIG. 9C, diagram 950 shows a surface 121 having a left hand knife edge 905L contact and a right hand knife edge 905R contact thereon and directional arrow 957 and 958. In diagram 975 of FIG. 9D the hands is now rotated into an open position such that the contact with surface 121 consists of left hand palm up 901L contact and a right hand palm up 901R contact. In other words, the user initially places both hands together and then places the knife edges of both hands on the surface 121. The user then rotates each hand about its knife edge until the backs of each hand is touching surface 121.

In operation, when monitoring module 510 receives the corresponding signals from capacitive touch sensor 230 and 3D motion sensor 195, monitoring module 510 will determine that the display screen has been touched and then the user's hands performed an opening up type motion. In one embodiment, monitoring module 510 will provide the unified gesture to gesture definer 520 which will correlate the contact and following motion with the action “open an e-book to start digital reading”. Gesture definer 520 will then signal operation module 530 to perform the above stated action 555.

In another example, assume the touching a display screen with an edge of a palm and then turning the hand to the right motion is not defined. When monitoring module 510 receives the signals from capacitive touch sensor 230 and 3D motion sensor 175, monitoring module 510 will combine the inputs into a unified gesture and provide the unified gesture to gesture definer 520 which will determine that the touching a display screen with an edge of a palm and then turning the hand to the right-gesture is associated with no action. As such, gesture definer 520 will not signal operation module 530 and no action will be performed.

In one embodiment, if a gesture with no associated action is performed a number of times within a certain time period, a help menu may pop up in an attempt to ascertain the user's intention. In one embodiment, the menu may provide insight to allow the user to find the proper gesture for the desired action. In another embodiment, the menu may include an “ignore this gesture” option. For example, if a user were a habitual tapper, after repeated tapping the help menu may pop-up to provide assistance. The user could simply select the “ignore this gesture” option and the gesture would then be ignored or the habitual tapping gesture may be assigned as “take no additional action”.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method for utilizing 3D gesture recognition for operating an electronic personal display, said method comprising:
receiving a contact at a capacitive touch sensing surface on at least a portion of the electronic personal display;
monitoring an airspace in range of a 3D motion sensor coupled with the electronic personal display for a motion associated with the contact;
correlating the contact and motion with a predefined gesture denoting a digital reading operation to be performed on a digital content item rendered on the electronic personal display; and
performing the digital reading operation on the electronic personal display.

2. The method of claim 1 further comprising:
receiving a back of both of a user's hands contact;
recognizing a hands closing together motion;
correlating the hands closing together motion with the predefined gesture denoting a book closing operation; and
performing the book closing operation.

3. The method of claim 1 further comprising:
receiving a knife edge of both of a user's hands contact;
recognizing a hands opening outward motion;
correlating the hands opening outward motion with the predefined gesture denoting a book opening operation; and
performing the book opening operation.

4. The method of claim 1 further comprising:
receiving a knife edge of a user's hand contact;
recognizing the user's hand rotating counter-clockwise from the knife edge of the user's hand to a palm of the user's hand as a counter-clockwise rotating motion;
correlating the counter-clockwise rotating motion with the predefined gesture denoting a book closing operation; and
performing the book closing operation.

5. The method of claim 1 further comprising:
receiving a knife edge of a user's hand contact;
recognizing the user's hand rotating clockwise from the knife edge of the user's hand to a back of the user's hand as a clockwise rotating motion;
correlating the clockwise rotating motion with the predefined gesture denoting a book opening operation; and
performing the book opening operation.

6. The method of claim 1 further comprising:
receiving a knife edge of a user's hand contact;
recognizing the user's hand rotating counter-clockwise about an axis perpendicular to the capacitive touch sensing surface as the predefined gesture related to a page forward operation; and
performing the page forward operation.

7. The method of claim 1 further comprising:
receiving a knife edge of a user's hand contact;
recognizing the user's hand rotating clockwise about an axis perpendicular to the capacitive touch sensing surface as the predefined gesture related to a page backward operation; and
performing the page backward operation.

8. The method of claim 1 further comprising:
receiving a knife edge of a user's hand contact at the capacitive touch sensing surface;
recognizing the user's hand rotating about an axis perpendicular to the capacitive touch sensing surface as the predefined gesture related to a bookmark page operation; and
performing the bookmark page operation.

9. The method of claim 1 further comprising:
fixedly coupling the 3D motion sensor with the electronic personal display.

10. An electronic reader (eReader) with 3D gesture recognition comprising:
a capacitive touch sensing surface on at least a portion of the eReader;
a 3D motion sensor coupled with an eReader;
a monitoring module to monitor the capacitive touch sensing surface for a contact and to monitor an airspace in range of the 3D motion sensor for a motion and provide an output when the contact and the motion are detected;
a gesture correlater to correlate the output from the monitoring module with a predefined gesture denoting a digital reading operation to be performed on a digital content item rendered on the eReader and provide a signal when the predefined gesture is detected; and
an operation module to receive the output from the gesture correlater and perform the digital reading operation on the eReader.

11. The eReader of claim 10 wherein the 3D motion sensor is fixedly coupled with the eReader.

12. The eReader of claim 10 wherein a book closing operation predefined gesture is selected from the group consisting of: the contact with a back of both of a user's hands at the capacitive touch sensing surface; and the motion of the user's hands closing together; and
the contact with a knife edge of the user's hand at the capacitive touch sensing surface; and the motion of the user's hand rotating counter-clockwise from the knife edge of the user's hand to a palm of the user's hand.

13. The eReader of claim 10 wherein a book opening operation predefined gesture is selected from the group consisting of: the contact with a knife edge of both of a user's hands at the capacitive touch sensing surface; and the motion of the user's hands opening outward; and
the contact with a knife edge of a user's hand at the capacitive touch sensing surface; and the motion of the user's hand rotating clockwise from the knife edge of the user's hand to a back of the user's hand.

14. The eReader of claim 10 wherein a page turning operation predefined gesture is selected from the group consisting of: the contact with a knife edge of a user's hand at the capacitive touch sensing surface; and the motion of the user's hand rotating counter-clockwise about an axis perpendicular to the capacitive touch sensing surface as a page turn forward operation; and
the contact with the knife edge of the user's hand at the capacitive touch sensing surface; and the motion of the user's hand rotating clockwise about the axis perpendicular to the capacitive touch sensing surface as a page turn backward operation.

15. The eReader of claim 14 wherein the axis perpendicular to the capacitive touch sensing surface is selected from the group consisting of: an axis about a user's wrist and an axis about a user's thumb.

16. The eReader of claim 10 wherein a page bookmarking operation predefined gesture comprises:
the contact with a knife edge of a user's hand at the capacitive touch sensing surface; and
the motion of the user's hand rotating about an axis perpendicular to the capacitive touch sensing surface.

17. A method for utilizing a 3D motion sensor to perform an operation on an electronic reader (eReader), said method comprising:
providing a capacitive touch sensing surface on at least a portion of the eReader,
coupling a 3D motion sensor with the eReader,
monitoring the capacitive touch sensing surface for a contact;
monitoring an airspace in range of the 3D motion for a motion associated with the contact;
comparing the contact and motion with a predefined set of gestures denoting a digital reading operation to be performed on a digital content item rendered on the eReader;
determining that the contact and motion are a proximate match to one of the predefined set of gestures; and
performing the digital reading operation on the eReader.

18. The method of claim 17 wherein a book closing operation predefined gesture is selected from the group consisting of:
receiving a back of both of a user's hands contact at the capacitive touch sensing surface; and recognizing a user's hands closing together motion; and
receiving a knife edge of a user's hand contact at the capacitive touch sensing surface; and recognizing the user's hand rotating counter-clockwise from the knife edge of the user's hand to a palm of the user's hand on the capacitive touch sensing surface as a counter-clockwise rotating motion.

19. The method of claim 17 wherein a book opening operation predefined gesture is selected from the group consisting of:
receiving a knife edge of a user's hands contact at the capacitive touch sensing surface; and recognizing a user's hands opening outward motion; and
receiving a back of a user's hand contact at the capacitive touch sensing surface; and recognizing the user's hand rotating clockwise from the knife edge of the user's hand to a back of the user's hand on the capacitive touch sensing surface as a counter-clockwise rotating motion.

20. The method of claim 17 wherein a page turning operation predefined gesture comprises:
receiving a knife edge of a user's hand contact at the capacitive touch sensing surface;
recognizing the user's hand rotating about an axis perpendicular to the capacitive touch sensing surface, wherein the user's hand rotating clockwise is a proximate match to the predefined gesture related to a page backward operation and the user's hand rotating counter-clockwise is a proximate match to the predefined gesture related to a page forward operation.
